(19) United States
(12) Patent Application Publication
(10) Pub. No.: US 2013/0000187 A1
(43) Pub. Date: Jan. 3, 2013

(54) VINEYARD POST WITH AT LEAST ONE TRANSVERSE EXTENSION ARM

(75) Inventor: Raimund RAISACHER, Bad Bergzabern (DE)

(73) Assignee: DR. REISACHER WINZERBEDARF GMBH, Neuhausen Auf Den Fildern (DE)

(21) Appl. No.: 13/535,656

(22) Filed: Jun. 28, 2012

(30) Foreign Application Priority Data
Jun. 28, 2011 (DE) 10 2011 106 730.6

(51) Int. Cl. A01G 17/14

(52) U.S. Cl. 47/46

(57) ABSTRACT

A post for retaining wires in wine and fruit growing includes a basic body with first and second limbs made of sheet metal, on which there is disposed at least one transverse extension arm running substantially at right angles to the longitudinal axis of the basic body and having a multiplicity of hooks and/or eyelets for retaining the wires. The first and second limbs each contain an opening with a shape adapted to the cross-sectional shape of the transverse extension arm, and through which the transverse extension arm can be pushed into the basic body, substantially at right angles to the longitudinal axis of the basic body, into a locking position. A quick-acting closure produces a form-locking connection between the basic body and the transverse extension arm, in the locking position.

### CROSS-REFERENCE TO RELATED APPLICATION

This application claims the priority, under 35 U.S.C. §119, of German Patent Application DE 10 2011 106 730.6, filed Jun. 28, 2011; the prior application is herewith incorporated by reference in its entirety.

### BACKGROUND OF THE INVENTION

### Field of the Invention

The invention relates to a vineyard post for retaining wires in wine and fruit growing. The post includes a basic body with first and second limbs made of sheet metal. At least one transverse extension arm is disposed thereon, runs substantially at right angles to the longitudinal axis of the basic body and has a multiplicity of hooks for retaining the wires.

It is known to use open or closed metal profiles for the purpose of tensioning espalier wires in wine and fruit growing. The metal profiles have limbs on which outer hooks are formed by punching out tongue-like portions of the basic material and bending them into shape. Such metal profiles, which will also be referred to below as vineyard posts, are known, for example, from German Patent DE 44 36 936 C2.

In the case of straight forward vineyard posts, the wires are mounted one above the other, on either side of the vines, in two vertical planes which run parallel to one another and a spacing between which is defined by a spacing of the limbs of the metal profiles.

From time to time, however, it is desirable for the wires to be mounted in more than just two planes running parallel to one another, for example in eight or 10 planes, for example in order to increase growth with vines per unit of surface area or in order to improve shading.

In order to meet that objective, transverse extension arms are fastened on the known vineyard posts. Although it is possible for the transverse carriers to be fixed to the vertical posts by welding at the production stage, in practice, for better handling and for reasons relating to space during storage, they are screwed directly to the posts. However, the mounting operation, which is necessary for fastening the transverse extension arms, is very time-consuming since a plurality of individual parts have to be laboriously connected to one another and a vineyard includes usually several 100 posts.

A further problem is that the screw connection which is carried out tends to come loose, due to constant wind movement transmitted to the wires through the vines and due to often large fluctuations in temperature in the event of pronounced insolation. Accordingly, the above-described vineyard posts with transverse extension arms have to be checked and maintained at appropriately frequent intervals, which in some cases is very time-consuming.

A further problem of the above-described vineyard posts with screw-connected transverse extension arms is that the transverse extension arms are screwed to the end side connecting the two limbs of the profiles at a distance from the center of inertia. That decentralized fastening of the transverse extension arms means that the post, in addition to the actual load-bearing force, has to apply an additional torque, which subjects the screw connection to additional loading and, in the case of relatively high wind loads and lack of maintenance, easily results in the failure of the screw connection between the transverse extension arm and vertical profile.

### SUMMARY OF THE INVENTION

It is accordingly an object of the invention to provide a vineyard post with at least one transverse extension arm, which overcomes the hereinafore-mentioned disadvantages of the heretofore-known devices of this general type, which can be stored in a space-saving manner and which can be mounted as well as removed, in an extremely short period of time, using straightforward measures.

With the foregoing and other objects in view there is provided, in accordance with the invention, a post for retaining wires in wine and fruit growing. The post comprises a basic body having a longitudinal axis and first and second limbs made of sheet metal, at least one transverse extension arm disposed on the limbs, running substantially at right angles to the longitudinal axis of the basic body, having a multiplicity of hooks and/or eyelets for retaining the wires and having a cross-sectional shape. The first and second limbs each have a respective opening formed therein with a shape adapted to the cross-sectional shape of the at least one transverse extension arm being configured to permit a transverse extension arm to be pushed through into the basic body, substantially at right angles to the longitudinal axis of the basic body, into a locking position. A quick-acting closure produces a form-locking connection between the basic body and the transverse extension arm in the locking position.

The basic body, which in the case of the preferred embodiment of the invention has a substantially U-shaped cross section, as well as the transverse extension arm, are obtained preferably by punching and bending into shape sheet metal which may, for example, have a thickness of 1.0 mm to 3.5 mm.

The invention is distinguished in that the first and second limbs of the profile of the basic body each contain an opening which has a shape adapted to the cross-sectional shape of the transverse extension arm. The openings, which are for example rectangular, are aligned in this case in the horizontal direction, and therefore the transverse extension arm can be pushed through the two openings into the basic body, substantially at right angles to the longitudinal axis of the same, into a locking position. The locking position in this case is located in the region of the center of the transverse extension arm, and this therefore gives rise to a cross-shaped configuration once the transverse extension arm has been pushed in. In order for the pushed-in transverse extension arm to be fixed on the basic body in the locking position, a quick-acting closure is also provided. The quick-acting closure produces a form-locking connection between the basic body and the transverse extension arm, in the locking position, with it being possible for this connection to be released again preferably by hand or also with the aid of straightforward tools. A form-locking connection is one which connects two elements together due to the shape of the elements themselves, as opposed to a force-locking connection, which locks the elements together by force external to the elements.

The invention has the advantage that substantially no accessory parts are required in order for the transverse extension arms according to the invention to be mounted, and therefore large numbers thereof can be mounted within an extremely short period of time. Using a quick-acting closure in conjunction with the openings formed in the limbs of the basic body in this case renders the assembled posts highly stable in relation to torques acting on the transverse profiles, as a result of which the posts can also readily absorb high wind loads. In addition, the device according to the invention makes it possible for the basic bodies and transverse extension arms, prior to being mounted, to be stored, and transported to the vineyards, in a space-saving manner, and this reduces the storage and transporting costs in comparison to prefabricated posts, in the case of which the basic bodies and transverse profiles are already fixed to one another at the production stage. In addition, handling during production of the posts according to the invention is improved.

In accordance with another feature of the invention, the quick-acting closure includes an inherently rigid stop, which is provided on the transverse extension arm and, in the locking position, butts against the basic body, and a resiliently elastic sheet-metal tongue, which is formed on the transverse extension arm and, in order to produce the form-locking connection, interacts with a latching mount on the basic body. This has the advantage that the transverse extension arm, when pushed through the two openings in the limbs of the basic body, is positioned, as it were, automatically in the locking position by the inherently rigid stop if the latter is butting against the outside of the associated limb.

In accordance with a further preferred feature of the invention, the transverse extension arm includes a sheet-metal profile, which is produced by being punched and bent into shape and on which the hooks are formed. The resiliently elastic sheet-metal tongue, in this case, is produced preferably in the same way as the hooks, by virtue of a tongue-like portion being punched out of the sheet-metal profile of the transverse extension arm and bent into shape, resulting in the production operation being simplified to a considerable extent. It is particularly advantageous in this case if the resiliently elastic sheet-metal tongue, in the same way as the hooks, includes a spring portion, which juts out of the sheet-metal profile of the transverse extension arm at an angle of preferably 80°, and a supporting portion, which runs substantially parallel to the outside of the sheet-metal profile and at the free end of which is formed a supporting surface, through which the transverse extension arm, in the locking position, is supported on the basic body. The supporting portion, which may, for example, have a length of 0.5 cm to 3.5 cm, preferably has a curved cross section, in order for the geometrical moment of inertia, and thus the stability of the same, to be increased.

The above-described configuration of the resiliently elastic sheet-metal tongues has the advantage that these tongues can be formed with the desired elasticity properties, and with a comparatively high level of precision, in the same production process, and using the same tools, as the transverse carriers and/or basic bodies.

In accordance with an added feature of the invention, the resiliently elastic sheet-metal tongues preferably each have an accommodating opening, which extends from the spring portion to the supporting surface and into which, in particular, a wedge can be introduced in order to produce, in the locking position, an inherently stable connection between the spring portion and the basic body, or in order for the transverse carrier, in the locking position, to be secured on the basic body in addition through an enlarged abutment surface area provided by the wedge.

This embodiment has the advantage that the wedge is secured automatically by gravitational force and, in addition, the surface area on which the impact tools of harvesting machines can act is very small, as a result of which the risk of the wedges accidentally becoming loose during harvesting can be reduced further. It is possible, if appropriate, for the wedges, following introduction into the respective accommodating opening, which is bounded in the outward direction by the supporting portion, to be deformed by a suitable tool, for example pliers, in order to attain an additional securing action.

Using an accommodating opening defined between the supporting portion and the outside of the relevant transverse profile gives the advantage in this case that the wedges are additionally clamped between the supporting portion and the transverse profile if the clear spacing between the inside of the supporting portion and the outside of the transverse profile is slightly smaller, for example by 0.5 mm, than the material thickness of the wedge. This gives rise to the wedges being additionally secured against sliding out accidentally.

In accordance with an additional feature of the invention, although it is possible for the inherently rigid stop to be provided by a bolt which is introduced into the transverse carrier and, once the transverse carrier has been pushed into the locking position, is introduced into an appropriately shaped opening in the transverse carrier, in which this opening runs preferably in the horizontal direction, the inherently rigid stop in the transverse carrier is configured preferably as a tongue-like protrusion, which is obtained, in the same way as the hooks, by virtue of a substantially rectilinear tongue-like portion being punched out of the sheet-metal material of the transverse extension arm, which is resiliently elastic to a certain extent, and bent into shape. The tongue-like portion in this case is preferably rectilinear and inclined at an angle of, for example, 10-30° in relation to the outer surface of the transverse extension arm, wherein the free end of the tongue-like portion, as the transverse extension arm is pushed into the openings in the basic body, is oriented away from the basic body. This has the advantage that the tongue-like portion, as the transverse extension arm is pushed in through the two openings in the basic body, is pushed back into the transverse extension arm, counter to its resiliently elastic prestressing, as it passes the respective peripheries of the first and second openings. When the locking position is reached, the tongue-like portion then springs automatically out of the outside of the transverse extension arm and butts, by way of its free end, against the outside of the basic body. The aforementioned angle range in this case ensures that, on one hand, the deformation of the sheet-metal material of the tongue-like portion is in the elastic range and, on the other hand, the high buckling strength of the sheet-metal material in the locking position is utilized in order to ensure sufficient strength of the stop.

In the case of the last-described embodiment of the invention, the region in which the free end of the tongue-like portion butts against the outside of the respective limb of the basic body preferably contains a groove-like depression, preferably a bead, which, in the locking position, secures the free end of the tongue-like portion in addition against lateral movement. This can advantageously further increase the retaining forces and the mechanical loading capability of the stop formed in this way.

As an alternative, however, it is likewise possible for the inherently rigid stop to be configured as a preferably cross-sectionally V-shaped spine of material, which juts out of the sheet-metal material of the transverse extension arm and is obtained, in particular, by virtue of the sheet-metal material being cold worked, or by virtue of a slot being introduced into the sheet-metal material and the material being pushed out. The operation of pushing in the transverse extension arm through the openings in the basic body, in this case, takes place as far as the V-shaped cross-sectional surface of the spine of material jutting out of the transverse extension arm in the region of the slot, in the direction counter to the resiliently elastic tongue-like portion of the above-described embodiment. In order to secure the transverse extension arm in the locking position, it is possible, in this case, to use a wedge or also a bolt, which is introduced, on that side of the basic body which is located opposite the spine of material, into an appropriate opening in the transverse extension arm.

In accordance with again another feature of the invention, the wedge opening is preferably an aperture which extends through the transverse extension arm in the direction of the longitudinal axis of the basic body and, in the locking position, extends beyond the outside of the basic body. The wedge, in this case, is plugged laterally into the aperture in a horizontal direction and has one side butting against the periphery of the aperture and its other side butting against the limb of the basic body.

Basic bodies which have only a very narrow profile shape have the advantage that the narrow profile of the basic body is supported, and braced, by the wedge, in addition, in the transverse direction, and this further increases the buckling strength of the basic profile.

In accordance with again a further preferred feature of the invention, the wedge opening is formed by the accommodating opening of a hook formed on the upper side of the transverse carrier, for example of an inner hook with an eyelet-like opening which is closed or also open at one point in the direction of the outside. In the same way, the wedge opening may also be the wire-accommodating portion of a tongue-like hook which is bent out of the profile of the transverse extension arm.

In accordance with again an added feature of the invention, it has proven particularly advantageous, in practice, if the basic body of the profile has formed on it a first bead, which forms the latching mount for the resiliently elastic sheet-metal tongue, and/or a second bead, which accommodates the inherently rigid stop, with the two beads extending preferably over the entire length of the basic body. The two beads are introduced into the limbs of the basic body, during production of the latter, by an appropriate stamping or profiling operation and run level with the inherently rigid stop, or level with the resiliently elastic sheet-metal tongue. Providing a bead has the advantage that the supporting surface of the resiliently elastic sheet-metal tongue and the stop surface of the inherently rigid stop are fixed in the bead, and therefore, when the transverse extension arm is subjected to a torque, they remain in their position and do not slide laterally along the outside of the limbs. This increases quite considerably the maximum retaining moment to which the transverse extension arm can be subjected.

In accordance with again an additional feature of the invention, the central region of the transverse extension arm contains two large apertures. On one hand, this allows the transverse extension arms to be screwed on in traditional fashion. On the other hand, a lever element can be introduced, from the open side of the basic profile, into the aperture located in the vicinity of the resiliently elastic sheet-metal tongue. This lever element, pushing against the opening of the limb of the basic profile, makes it possible for the transverse extension arm to be displaced and thus closed or opened.

In accordance with yet another feature of the invention, the end surface of the basic body, level with the openings for accommodating the transverse extension arm, contains at least one further opening. The further opening is positioned in such a way that, in the locking position, it is aligned substantially with an aperture in the transverse extension arm in such a way that, by virtue of a lever element, for example a bar or a rod, being introduced from the outside, the transverse extension arm can be displaced relative to the basic body in order for the quick-acting closure to be closed or opened. The operation of closing or opening the quick-acting closure takes place, in the case of this embodiment, by using a resiliently elastic sheet-metal tongue in that, by virtue of the rod introduced into the aperture of the transverse extension arm through the further opening being pivoted horizontally, the transverse extension arm is displaced, counter to the force applied by the resiliently elastic sheet-metal tongue, until the free end of the substantially rectilinear sheet-metal tongue of the inherently rigid stop springs out of the associated punched opening and butts against the outer surface of the basic body, alongside the opening in the limb of the latter. The last-described embodiments of the invention have the advantage that the transverse extension arms can be mounted on the basic bodies in an extremely short period of time and by one person alone. This means that, in the case of basic bodies which are equipped, in a known manner, with conventional outer and also inner hooks for accommodating wires on the two limbs, the transverse extension arms can be retrofitted in an extremely short period of time by one person alone. In the same way, it is possible for the transverse extension arms, in the case of the last-described embodiment, to be released again and removed, if required, very straightforwardly with the aid of the rod introduced into the further opening.

In accordance with a concomitant feature of the invention, the transverse extension arm has further apertures and elements, on which accessories, e.g. hail nets and irrigation lines, can be straightforwardly fitted or mounted.

Other features which are considered as characteristic for the invention are set forth in the appended claims.

Although the invention is illustrated and described herein as embodied in a vineyard post with at least one transverse extension arm, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side-perspective view of a post according to the invention with a transverse extension arm mounted thereon, for depicting an abutment of a resiliently elastic sheet-metal tongue on a limb of a basic body;

FIG. 2 is a side-perspective view of the side of the post opposite that shown in FIG. 1, for depicting an abutment of an inherently rigid stop on the limb of the basic body;

FIG. 3 is a rear-perspective view of another embodiment of a post according to the invention, in the case of which the transverse extension arm is secured by a wedge pushed in the horizontal direction into an accommodating opening of a resiliently elastic sheet-metal tongue;

FIG. 4 is a front-elevational view of the post of FIG. 3;

FIG. 5 is a plan view of the post of FIG. 3;

FIG. 6 is a front-elevational view of a further embodiment of a post according to the invention, in the case of which a quick-acting closure includes a bolt, which is accommodated in the horizontal direction in an appropriate opening in the transverse extension arm, and a horizontal wedge;

FIG. 7 is a plan view of the post of FIG. 6;

FIG. 8 is a front-elevational view of a modified embodiment of the post of FIG. 1, in the case of which the limbs of the basic body contain additional beads and an end surface of the basic body, as well as a transverse carrier, contain openings for the introduction of a lever element; and

FIG. 9 is a plan view of the post of FIG. 8.

### DETAILED DESCRIPTION OF THE INVENTION

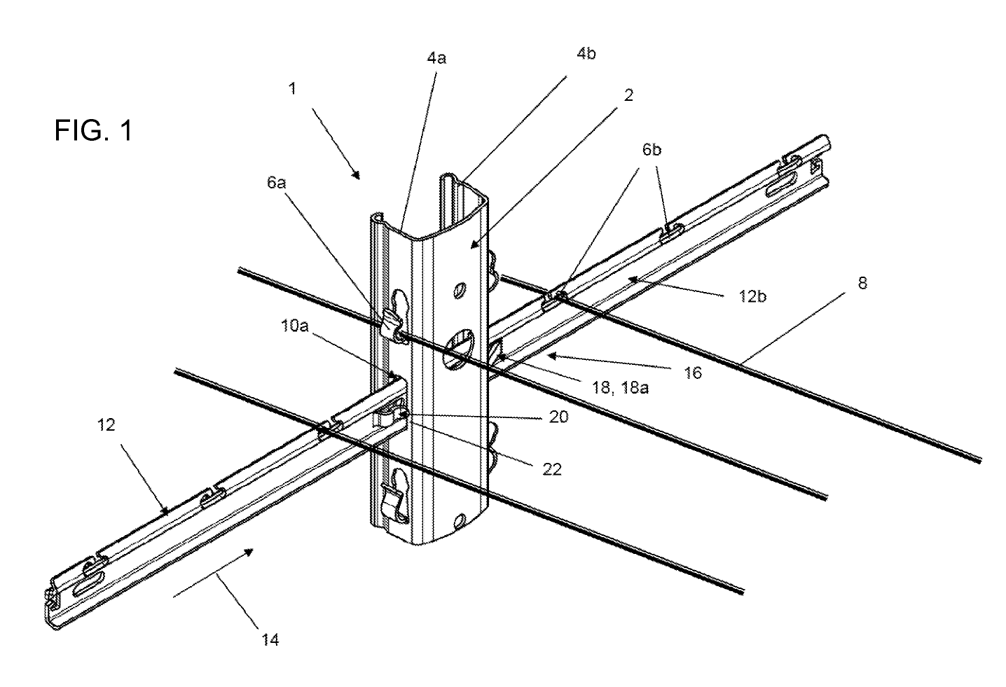

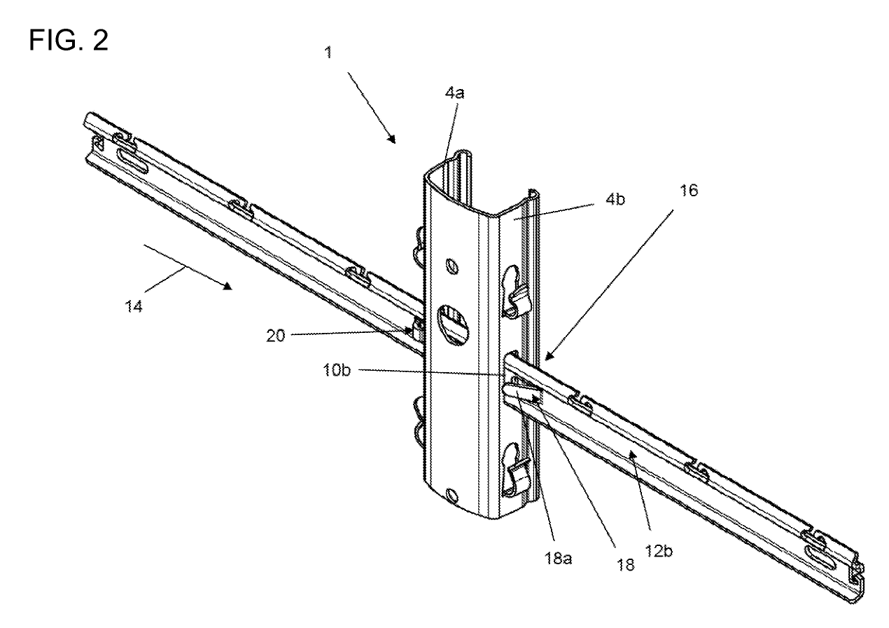

Referring now to the figures of the drawings in detail and first, particularly, to FIGS. 1 and 2 thereof, there is seen a post or stake 1 according to the invention which includes a basic body 2 that is formed of sheet metal, in particular of sheet steel, and has a substantially U-shaped cross section with limbs 4a, 4b, on which hook members configured as hooks or eyelets 6a according to the invention are formed for the purpose of accommodating wires 8. The first and second limbs 4a, 4b each contain an opening 10a, 10b, through which a transverse extension arm 12, with hook members configured as further hooks or eyelets 6b for accommodating further wires 8, can be pushed from the side, substantially at right angles to the longitudinal axis of the basic body 2, in the direction of an arrow 14 into a locking position, which is shown in FIGS. 1 and 2. A non-illustrated lower end of the basic body 2 is inserted in a known manner into the ground. When the following text makes reference to hooks 6a, 6b, this likewise also covers closed eyelets, through which the wires 8 are guided. For the sake of simplicity, the figures illustrate in each case just one transverse extension arm per basic profile. In practice, usually a plurality of transverse extension arms of different lengths are mounted one above the other on a basic profile.

As can further be gathered from the illustration of FIGS. 1 and 2, the post 1 according to the invention further includes a quick-acting closure 16 which, in the locking position, produces a form-locking connection between the basic body 2 and the transverse extension arm 12 in order for the transverse extension arm 12, in the locking position shown, to be secured against rotation in the horizontal and vertical planes.

In the case of that embodiment of the invention which is illustrated in FIG. 2, the quick-acting closure 16 includes an inherently rigid stop 18, which is provided on the transverse extension arm 12 and, in the locking position, abuts against the basic body 2, and a resiliently elastic sheet-metal tongue 20, which is formed on the transverse extension arm 12 and, in order to produce the form-locking connection, interacts with a latching mount 22 on the basic body 2. In the simplest case, the latching mount 22 is the outer surface of the associated limb 4a or 4b, but it may also be configured as a bead 22a, as is shown in detail in the cross-sectional view of FIG. 9.

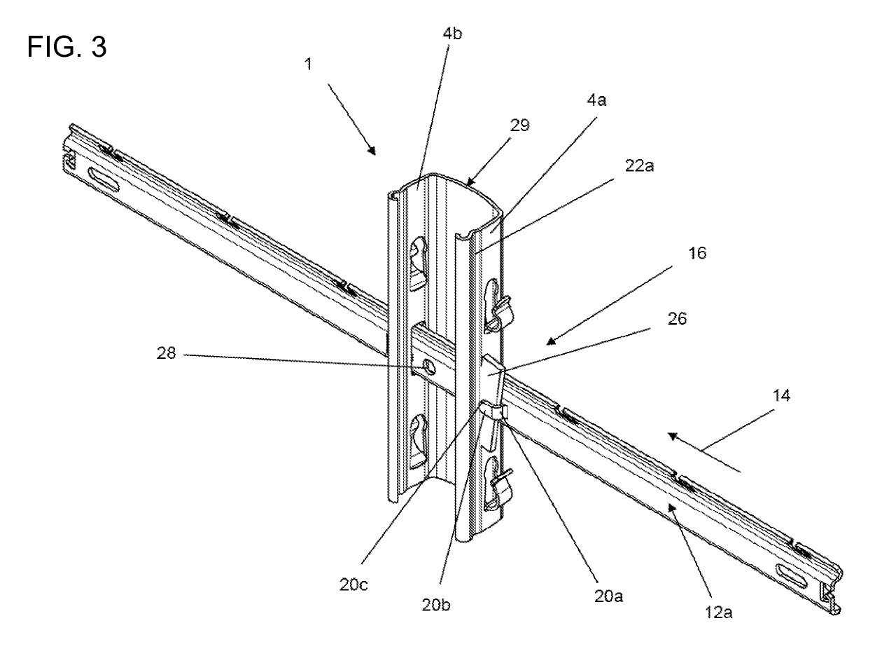

As can also be gathered in detail from the illustration of FIGS. 1 and 9, the resiliently elastic sheet-metal tongue 20 has a spring portion 20a, which juts out of the sheet-metal profile of the transverse extension arm 12 at an angle of, for example, 80°, and a supporting portion 20b, which runs substantially parallel to the outside of the sheet-metal profile and at the free end of which is formed a supporting surface 20c, through which the transverse arm 12, in the locking position, is supported in the latching mount 22, or in the bead 22a, on the basic body. Due to its cross-sectional shape, the resiliently elastic sheet-metal tongue 20 forms an accommodating opening 24, which is shown in FIG. 9, extends from the spring portion 20a to the supporting surface 20c and into which, if required, a wedge 26 can be introduced for additionally securing the transverse extension arm 12 in the locking position, as is shown in FIGS. 3, 4 and 5.

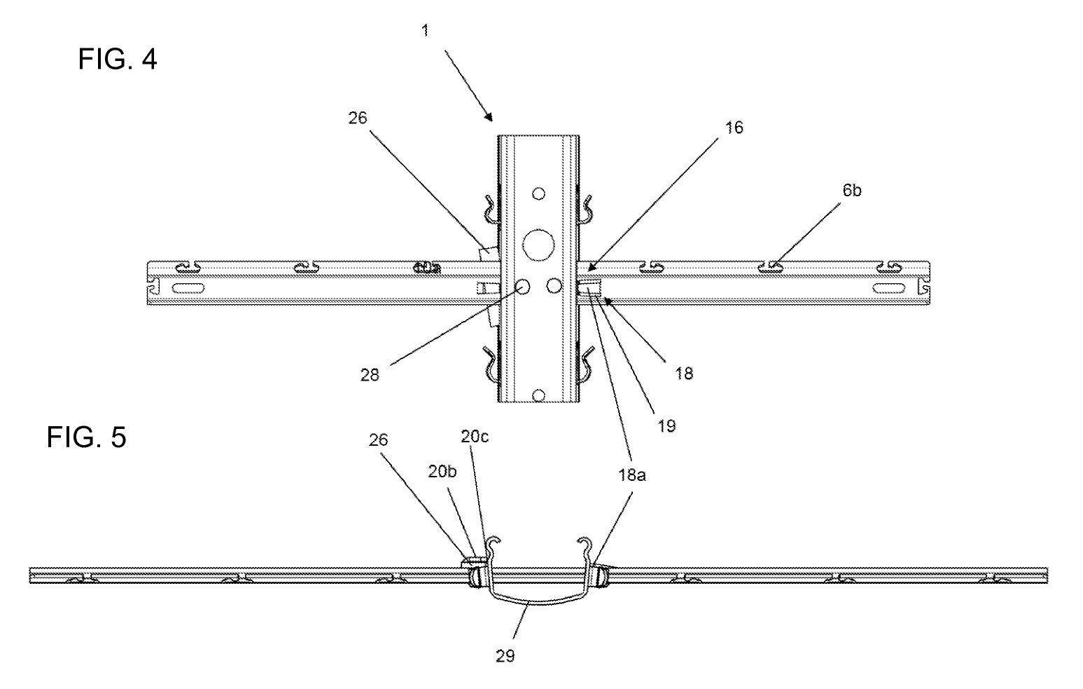

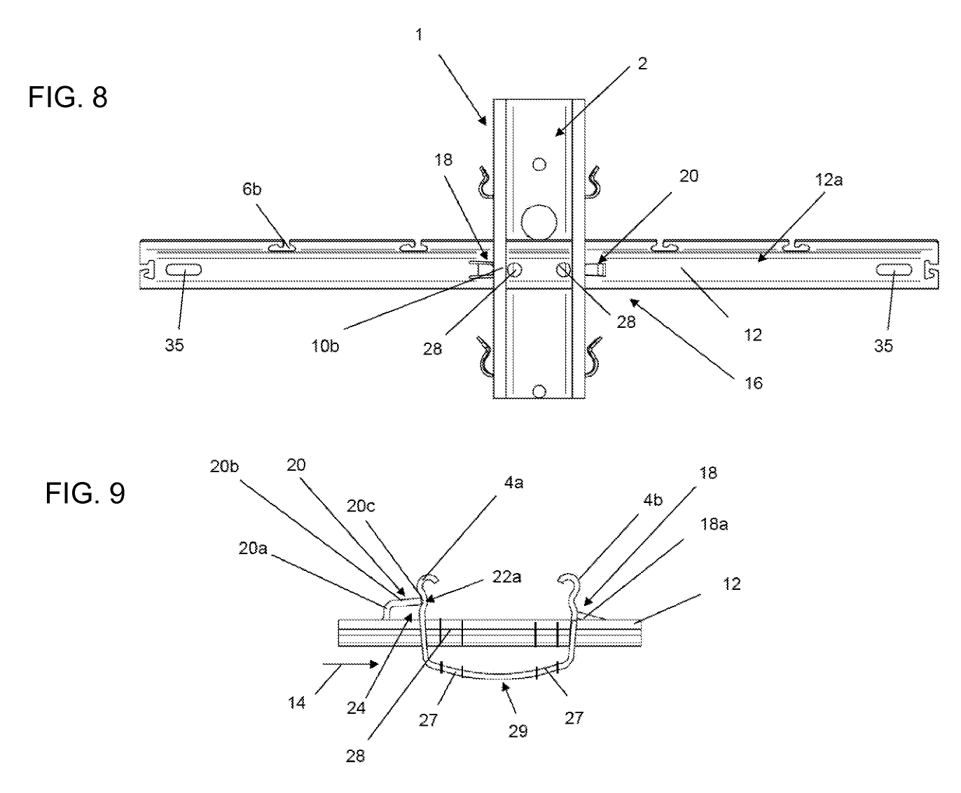

In the case of that embodiment of the invention which is shown in FIGS. 1 to 5 and also FIGS. 8 and 9, the inherently rigid stop 18 is formed by a tongue-like protrusion 18a, which is formed on the transverse extension arm 12 and extends at an angle of, for example, 20° or more from the outer surface 12a or the inner surface 12b of the profile of the transverse extension arm 12, as is shown in the aforementioned figures. The angle of the inherently rigid stop 18 and the length of the tongue-like protrusion 18a are selected in this case in such a way that the tongue-like protrusion 18, as the transverse extension arm 12 is pushed in through the openings 10a, 10b in the direction of the arrow 14, is pushed back into the punched opening 19 in the profile of the transverse extension arm 12. It is only when the definitive locking position is reached that the free end of the tongue-like protrusion 18a, due to the elastic properties of the sheet steel being used, springs out of the punched opening 19 (FIG. 4) and extends obliquely, at the aforementioned angle, as far as the second limb 4b. Since, in this position of the tongue-like protrusion 18a, it is possible for the transverse extension arm 12 to be pushed back counter to the arrow direction 14 only when the protrusion 18a is pushed back into the associated punched opening 19 in the transverse extension arm 12, the tongue-like protrusion forms an inherently rigid stop 18 which is activated, as it were, automatically when the transverse extension arm 12 is pushed in.

As can further be gathered from the illustration of FIGS. 8 and 9, the end side 29 of the basic body 2 may contain one or more openings 27 which, in the locking position, correspond with an appropriate aperture 28 in the transverse profile 12, and through which the end of a non-illustrated lever rod can be introduced in order to displace the transverse extension arm 12, counter to the resiliently elastic force of the spring portion 20a in the direction of the arrow 14, beyond the locking position and thus to allow the tongue-like protrusion 18a to spring out of the outer surface 12a. As an alternative, it is possible for a non-illustrated lever rod to be introduced, from the open profile mouth of the basic body, into an appropriate aperture 28 and pushed against a profile limb 4a or 4b. If the spacing between the supporting surface 20c and the abutment surface of the protrusion 18a is slightly smaller than the spacing between the latching mount 22 and that abutment surface on the second limb 4b against which the free end of the tongue-like protrusion 18a butts against the second limb, the transverse extension arm is braced elastically between the tongues. If this difference in spacing is slightly greater, then the transverse extension arm can easily be pushed, with a slight amount of play, into the basic profile and latched. FIG. 8 also shows that the transverse extension arm has branches with further apertures 35 formed therein for fastening accessories.

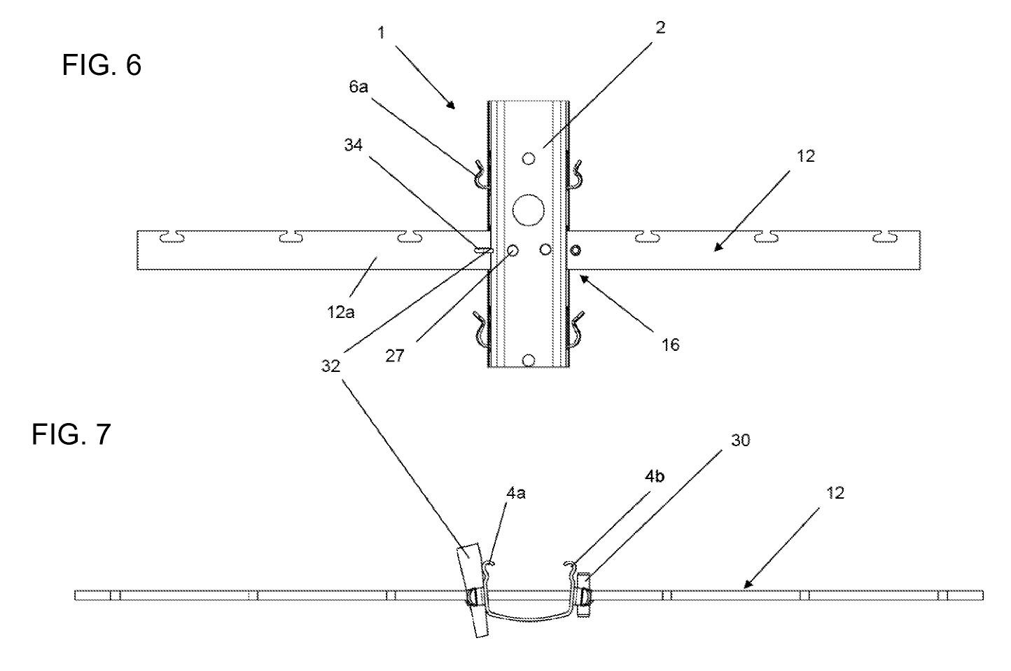

As an alternative, it is possible for the inherently rigid stop to be configured as a bolt 30, which is plugged in the horizontal direction into an appropriate opening in the profile of the transverse extension arm 12, as is shown in FIGS. 6 and 7. The transverse extension arm 12 is secured and braced in relation to the basic body 2 in this case preferably by a wedge 32, which is driven into a horizontally running opening 34 in the transverse profile 12.

1. A post for retaining wires in wine and fruit growing, the post comprising:
a basic body having a longitudinal axis and first and second limbs made of sheet metal;
at least one transverse extension arm disposed on said limbs, running substantially at right angles to said longitudinal axis of said basic body, having a multiplicity of hook members for retaining the wires and having a cross-sectional shape;
said first and second limbs each having a respective opening formed therein with a shape adapted to said cross-sectional shape of said at least one transverse extension arm and configured to permit a transverse extension arm to be pushed through into said basic body, substantially at right angles to said longitudinal axis of said basic body, into a locking position; and
a quick-acting closure producing a form-locking connection between said basic body and said transverse extension arm in said locking position.

2. The post according to claim 1, wherein:
said basic body has a latching mount; and
said quick-acting closure includes:
an inherently rigid stop provided on said at least one transverse extension arm and abutting against said basic body in said locking position, and
a resiliently elastic sheet-metal tongue formed on said at least one transverse extension arm and interacting with said latching mount to produce said form-locking connection and secure said at least one transverse extension arm, in said locking position, against movement relative to said basic body.

3. The post according to claim 2, wherein:
said at least one transverse extension arm includes a sheet-metal profile, on which said hook members are formed as hooks or eyelets; and
said resiliently elastic sheet-metal tongue is a tongue-shaped portion punched out of said sheet-metal profile of said at least one transverse extension arm and bent into shape.

4. The post according to claim 3, wherein said resiliently elastic sheet-metal tongue includes:
a spring portion jutting out of said sheet-metal profile of said at least one transverse extension arm, and
a supporting portion running substantially parallel to an outer surface of said at least one transverse extension arm and having a free end at which a supporting surface is formed through which said at least one transverse extension arm is supported on said basic body in said locking position.

5. The post according to claim 4, wherein said spring portion juts out of said sheet-metal profile of said at least one transverse extension arm at an angle of substantially 80°.

6. The post according to claim 4, wherein said resiliently elastic sheet-metal tongue has an accommodating opening formed therein extending from said spring portion to said supporting surface and configured for permitting introduction of a wedge to produce an inherently stable connection between said spring portion and said basic body in said locking position.

7. The post according to claim 2, wherein said inherently rigid stop includes a bolt accommodated in said at least one transverse extension arm.

8. The post according to claim 2, wherein said inherently rigid stop includes a tongue-like protrusion formed on said at least one transverse extension arm.

9. The post according to claim 2, wherein said inherently rigid stop includes a spine of material pushed out of material of said at least one transverse extension arm by cold working.

10. The post according to claim 1, wherein said quick-acting closure includes a wedge acting between said basic body and said at least one transverse extension arm and configured to be introduced into a wedge opening provided on said at least one transverse extension arm.

11. The post according to claim 10, wherein said wedge opening includes an aperture formed on said at least one transverse extension arm, said aperture extending in direction of said longitudinal axis of said basic body, extending as far as an outer surface of said basic body in said locking position, and configured to receive said wedge in vertical direction from above.

12. The post according to claim 10, wherein:
said at least one transverse extension arm has a longitudinal axis; and
said wedge opening includes an aperture:
extending in a direction perpendicular to said longitudinal axis of said basic body,
extending perpendicular to said longitudinal axis of said at least one transverse extension arm,
extending through said at least one transverse extension arm,
extending beyond an outer surface of said basic body in said locking position, and
configured to receive said wedge in horizontal direction.

13. The post according to claim 10, wherein said at least one transverse extension arm has an upper surface with a hook of said hook members formed thereon and said wedge opening is a wire-accommodating opening of said hook.

14. The post according to claim 2, wherein formed on said basic body is at least one of a first bead forming a latching mount for said resiliently elastic sheet-metal tongue or a second bead accommodating said inherently rigid stop.

15. The post according to claim 1, wherein said at least one transverse extension arm has a profile and a central region containing two apertures positioned within said profile, in vicinity of said profile limbs, in said locking position.

16. The post according to claim 1, wherein said basic body has an end side level with said openings for accommodating said at least one transverse extension arm, said end side has at least one further opening formed therein substantially in alignment with an aperture formed in said at least one transverse extension arm, in said locking position, and configured to permit introduction of a lever element from outside to displace said at least one transverse extension arm relative to said basic body for opening or closing said quick-acting closure.

17. The post according to claim 1, wherein said at least one transverse extension arm has branches with further apertures formed therein for fastening accessories.
